(19) United States
(12) Patent Application Publication
(10) Pub. No.: US 2009/0238623 A1
(43) Pub. Date: Sep. 24, 2009

(54) IMAGE FORMING APPARATUS

(76) Inventor: Kazumi Kobayashi, Tokyo (JP)

Correspondence Address: DICKSTEIN SHAPIRO LLP, 1825 EYE STREET NW, Washington, DC, 20006-5403, US

(21) Appl. No.: 12/405,762

(22) Filed: Mar. 17, 2009

(30) Foreign Application Priority Data
Mar. 18, 2008 (JP) 2008-069664

(51) Int. Cl. G03G 15/00

(52) U.S. Cl. 399/405

(57) ABSTRACT

An image forming apparatus includes an image reader, an image forming unit, a sheet discharge device, a sheet receiver, and a sheet moving mechanism. The image reader provided substantially at an upper portion of the image forming apparatus reads an image of a document. The image forming unit disposed substantially below the image reader through some space forms an image based on image information read by the image reader and transfers the image onto a recording medium. The sheet discharge device discharges the recording medium on which an image is formed. The sheet receiver provided in the space between an upper portion of the image forming unit and a bottom portion of the image reader receives the recording medium discharged by the sheet discharge device. The sheet moving mechanism moves the recording medium that is discharged onto the sheet receiver by the sheet discharge device in a desired direction.

### CROSS-REFERENCE TO RELATED APPLICATIONS

This patent application is based on and claims priority pursuant to 35 U.S.C. §119 from Japanese Patent Application No. 2008-069664 filed on Mar. 18, 2008 in the Japan Patent Office, the entire contents of which are hereby incorporated herein by reference.

### BACKGROUND OF THE INVENTION

1. Field of the Invention

Exemplary aspects of the present invention generally relate to an image forming apparatus, such as a copier, a facsimile machine, a printer, or a digital multifunction system including a combination of at least two of these functions.

2. Description of the Background Art

In a generally-known electrophotographic image forming apparatus such as a copier, an original document is read by a document reader provided substantially at an upper portion of the image forming apparatus. Based on image information read by the document reader, an image is optically written on a surface of a photoreceptor drum in an image forming unit so as to form an electrostatic latent image on the photoreceptor drum.

Subsequently, the electrostatic latent image on the photoreceptor drum is developed with toner into a visible image, also known as a toner image. Thereafter, in a transfer unit, the visible image is transferred onto a recording medium such as a paper sheet or the like.

Subsequently, the unfixed toner image on the recording medium is fixed and discharged onto a sheet receiving tray provided at a side surface of the image forming apparatus.

A drawback to the foregoing configuration is that, because the sheet receiving tray sticks out from the side surface of the image forming apparatus, the image forming apparatus as a whole occupies a relatively large space, thus limiting flexibility in the choice of locations for the image forming apparatus in an office, for example.

In view of the above, an image forming apparatus capable of receiving the discharged recording medium inside a space defined by the main body of the image forming apparatus to reduce its overall footprint is proposed.

In such an image forming apparatus, the recording medium after the image is fixed thereon is discharged to a discharged sheet receiver provided in a space between the document reader and the image forming unit. In other words, the recording medium is discharged substantially below the document reader but substantially above the image forming unit. The discharged sheet receiver receives and stores the discharged sheet.

Such an image forming apparatus that discharges the recording sheet internally positions the image forming unit substantially at the center of the image forming apparatus. A plurality of sheet feed cassettes is provided substantially below the image forming unit. The document reader is provided substantially above the image forming unit, defining a space therebetween. Generally, three sides of the discharged sheet receiver, except for a front side corresponding to the front side of the image forming apparatus, are enclosed by sides, or walls, of the image forming apparatus.

In order to be able to accommodate a connection with a finisher and so forth, an image forming apparatus in which, in addition to the front side of the discharged sheet receiver, a side of the discharged sheet receiver in a sheet discharge direction is not covered by the wall of the image forming apparatus, is also proposed.

With reference to FIG. 1, a description is provided of the generally-known image forming apparatus that discharges the recording sheet internally. FIG. 1 is a schematic diagram illustrating a related-art internal sheet discharge portion of the image forming apparatus.

As illustrated in FIG. 1, an image reader (scanner) 514 is provided substantially above an internal sheet discharge portion 512 (hereinafter simply referred to as a sheet discharge portion). An image forming unit (printing portion) 510 is provided substantially below the sheet discharge portion 512. In other words, between the image reader 514 and the image forming unit 510, the sheet discharge portion 512 is provided.

The recording medium, on which an image is transferred in the image forming unit 510, is transported to a fixing device through a sheet transport path. After the image is fixed onto the recording medium, the recording medium is discharged to the sheet discharge portion 512 by a sheet discharge roller 545 serving as a first sheet discharge device.

Subsequently, the discharged recording sheet is stacked onto a sheet receiver 500.

A drawback to this configuration illustrated in FIG. 1 is that the sheet discharge portion 512 is located between the image reader 514 and the image forming unit 510, and the recording sheet is discharged on a bottom surface of the sheet discharge portion 512 so that the image reader 514 prevents a standing user of the image forming apparatus from seeing the discharged recording sheet well.

Furthermore, since the image reader 514 is provided substantially at the upper portion of the image forming apparatus, the user either needs to lean forward to retrieve the discharged recording medium on which the image is formed from the sheet receiver 500 or is obliged to retrieve the recording medium without being able to see well the discharged recording sheet.

Consequently, with this configuration, although the purpose of achieving reduction in the size of the image forming apparatus as a whole can be satisfied, there is a drawback in terms of usability for the user.

### SUMMARY OF THE INVENTION

Illustrative embodiments of the present invention provide an image forming apparatus that allows a user to pick up a discharged sheet with ease.

In view of the foregoing, in one illustrative embodiment of the present invention, an image forming apparatus for forming an image includes an image reader, an image forming unit, a sheet discharge device, a sheet receiver, and a sheet moving mechanism. The image reader is provided substantially at an upper portion of the image forming apparatus and configured to read an image of a document. The image forming unit is disposed substantially below the image reader through some space and is configured to form an image based on image information read by the image reader and transfer the image onto a recording medium. The sheet discharge device is configured to discharge the recording medium on which an image is formed. The sheet receiver is provided in the space between an upper portion of the image forming unit and a bottom portion of the image reader and configured to receive the recording medium discharged by the sheet discharge device. The sheet moving mechanism is configured to move the recording medium that is discharged onto the sheet receiver by the sheet discharge device in a desired direction.

Additional features and advantages of the present invention will be more fully apparent from the following detailed description of illustrative embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of illustrative embodiments when considered in connection with the accompanying drawings, wherein:

FIG. 1 is a schematic diagram illustrating a related art sheet discharge portion of an image forming apparatus;

FIG. 2 is a perspective view of an electrophotographic color copier as an example of an image forming apparatus as viewed from a substantially front upper right thereof according to an illustrative embodiment of the present invention;

FIG. 3 is a perspective view of the image forming apparatus of FIG. 2 as viewed from a substantially front upper left thereof according to an illustrative embodiment of the present invention;

FIG. 4 is a schematic diagram illustrating inside the image forming apparatus according to an illustrative embodiment of the present invention;

FIG. 5 is a schematic diagram illustrating a sheet discharge portion of the image forming apparatus according to a first illustrative embodiment of the present invention;

FIG. 6 is a schematic diagram illustrating a sheet discharge portion of the image forming apparatus according to a second illustrative embodiment of the present invention;

FIG. 7 is a schematic diagram illustrating a sheet discharge portion of the image forming apparatus according to a third illustrative embodiment of the present invention;

FIG. 8 is a schematic diagram illustrating a sheet discharge portion of the image forming apparatus according to a fourth illustrative embodiment of the present invention;

FIG. 9 is a schematic diagram illustrating a sheet discharge portion of the image forming apparatus according to a fifth illustrative embodiment of the present invention;

FIG. 10 is a schematic diagram illustrating a sheet discharge portion of the image forming apparatus according to a sixth illustrative embodiment of the present invention; and

FIG. 11 is a schematic diagram illustrating a sheet discharge portion of the image forming apparatus according to a seventh illustrative embodiment of the present invention.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and alternative example, for the sake of simplicity of drawings and descriptions, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but includes other printable media as well.

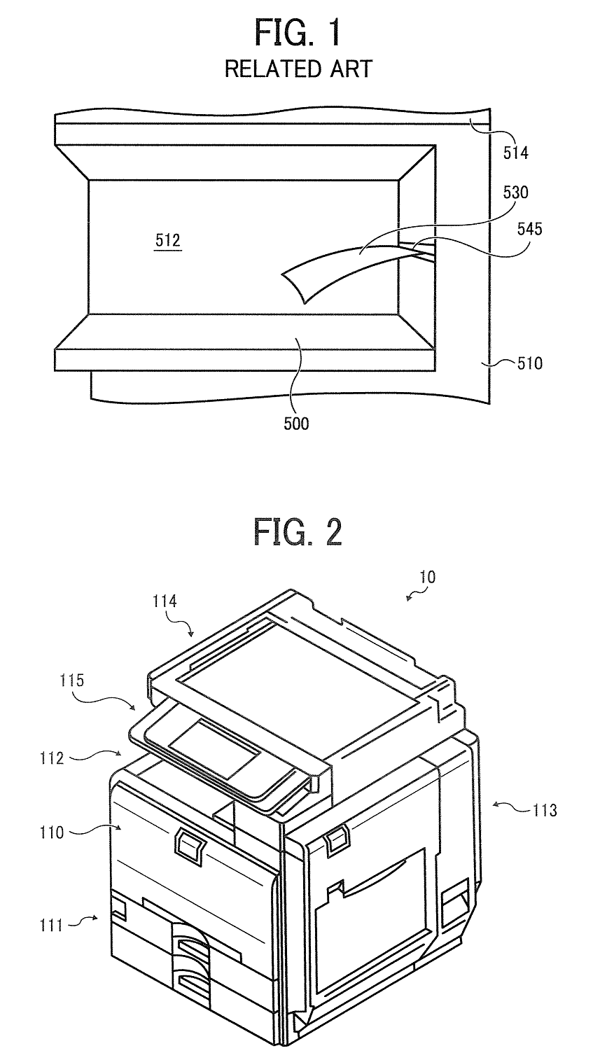

Referring now to the drawings, wherein like reference numerals designate identical or corresponding parts throughout the several views, and initially to FIG. 1, one example of an image forming apparatus according to an illustrative embodiment of the present invention is described.

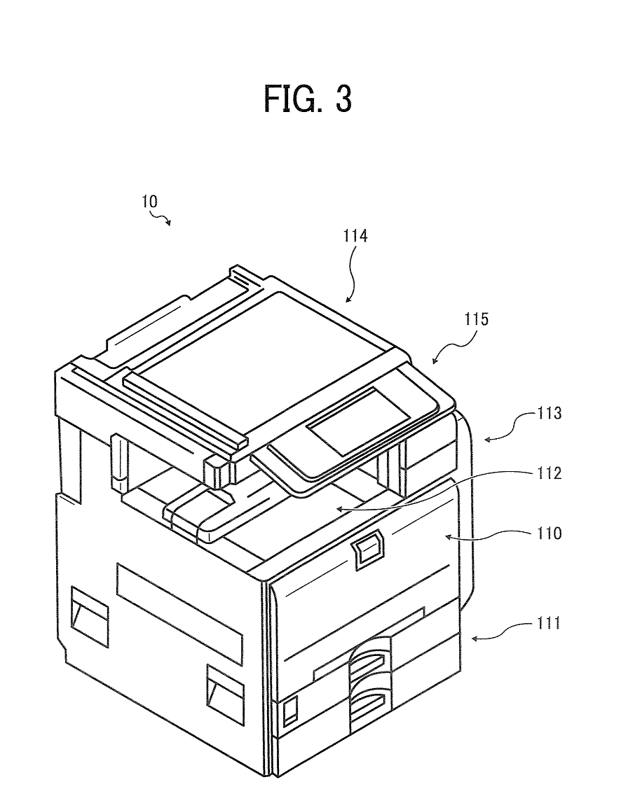

Referring now to FIGS. 2 and 3, there are provided perspective views of an electrophotographic color copier as an example of an image forming apparatus according to the illustrative embodiment. FIG. 2 illustrates an image forming apparatus 10 as viewed from a substantially front upper right of the image forming apparatus 10. FIG. 3 illustrates the image forming apparatus 10 as viewed from a substantially front upper left thereof.

As illustrated in FIGS. 2 and 3, the image forming apparatus 10 includes an image forming unit 110, a sheet feeder 111, an internal sheet discharge portion 112, a duplex unit 113, an image reader 114, a control panel 115 including a display panel and operation buttons, and so forth.

The image forming unit 110 forms and transfers an image onto a recording medium. Substantially below the image forming unit 110, the sheet feeder 111 that stores a stack of recording media sheets is disposed. The sheet feeder 111 picks up the recording medium one sheet at a time and sends the recording medium to the image forming unit 110.

The internal sheet discharge unit 112 discharges the recording medium on which an image is recorded. When an image is formed on the other side of the recording medium as well, the duplex unit 113 turns over the recording medium and sends the recording medium to the image forming unit 110 again.

The image reading unit 114 includes a contact glass on which an original document is placed and reads an image of the document.

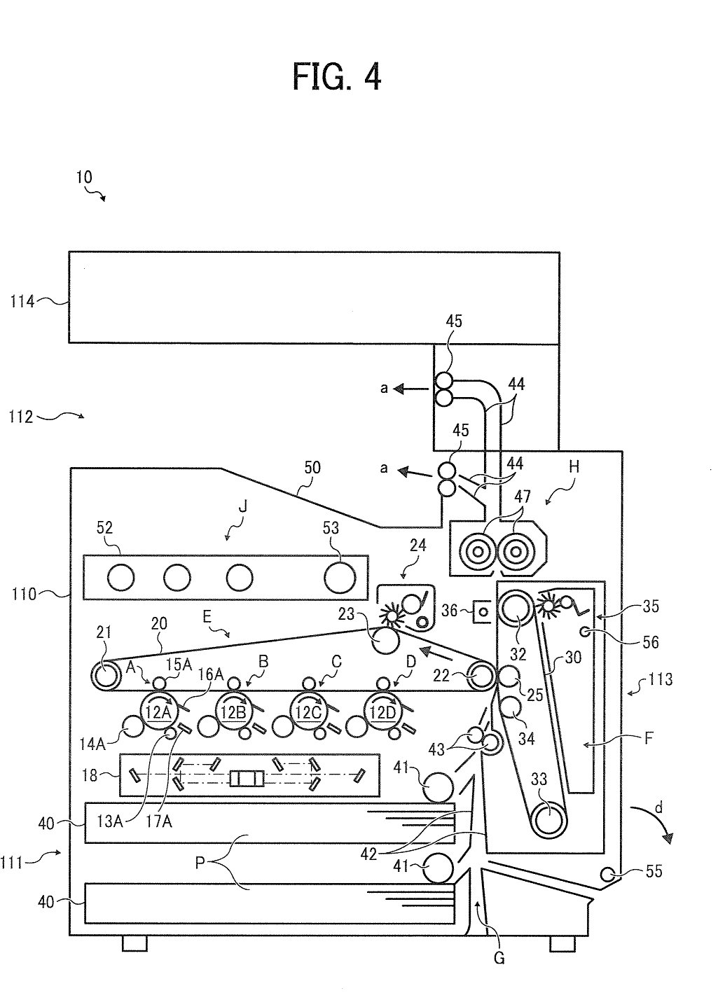

Referring now to FIG. 4, there is provided a schematic diagram illustrating inside the image forming apparatus 10. The image forming apparatus 10 illustrated in FIG. 4 is a color copier as an example of the image forming apparatus.

The image forming unit 110 of the image forming apparatus 10 includes four image forming stations A, B, C, and D, a primary transfer unit E, a secondary transfer unit F, a sheet transport device G, a fixing device H, a toner feeding device J, and so forth.

The four image forming stations A, B, C, and D forms an image of yellow (Y), magenta (M), cyan (C), and black (K), respectively, using respective colors of toner. Each of the image forming stations A, B, C, and D includes a drum-type photoreceptor 12A, 12B, 12C, and 12D, each of which serves as an image bearing member. The photoreceptor drums 12A, 12B, 12C, and 12D are rotatably supported and arranged in tandem.

Around each of the photoreceptor drums 12A, 12B, 12C, and 12D, a charging device 13, a developing device 14, a transfer member 15 disposed opposite the photoreceptor drum 12, a cleaning device 16, and a charge neutralizer 17 are provided.

Substantially below the image forming stations A, B, C, and D, an exposure unit 18 is provided so as to expose each of the photoreceptor drums 12A, 12B, 12C, and 12D.

It is to be noted that the image forming stations A, B, C, and D have the same configuration as all the others, differing only in the color of toner employed. Similarly, the photoreceptor drums 12A, 12B, 12C, and 12D have the same configuration as all the others, differing only in the color of toner employed.

For simplicity, a description will be provided of the image forming station A and the photoreceptor drum 12A as a representative example, unless otherwise specified.

The exposure unit 18 illuminates the surface of the photoreceptor drum 12A with a laser beam emitted from a light source using optical parts, not illustrated. The exposure unit 18 optically scans the surface of the photoreceptor drum 12A and optically writes forming a latent image thereon.

The primary transfer unit E serves as a primary image bearing mechanism and includes a primary image bearing member 20, three primary transfer rollers 21, 22, and 23, a primary cleaning unit 24, and a primary transfer member 25.

The primary image bearing member 20 is a belt member that contacts each of the photoreceptor drums 12A through 12D and is sandwiched between each of the photoreceptor drums 12A through 12D and the respective transfer members 15. The primary image bearing member 20 is wound around and stretched by the primary transfer rollers 21, 22, and 23.

The primary cleaning unit 24 and the primary transfer member 25 are disposed in the vicinity of the primary image bearing member 20.

The secondary transfer unit F serves as a secondary image bearing mechanism and includes a secondary image bearing member 30, three secondary rollers 32, 33, and 34, a secondary cleaning unit 35, and a secondary transfer device 36.

The secondary image bearing member 30 is a belt member that contacts the primary image bearing member 20, thereby forming a transfer nip therebetween. The secondary image bearing member 30 is wound around and stretched by the secondary rollers 32, 33, and 34, and passes between the primary image bearing member 20 and the primary transfer member 25.

The secondary cleaning unit 35 and the secondary transfer device 36 are disposed in the vicinity of the secondary roller 32.

The sheet transport device G that transports the recording medium P includes a sheet transport path that extends upward from substantially the bottom of the image forming apparatus 10. The sheet transport path is provided between the primary transfer unit E and the secondary transfer unit F.

The sheet transport device G includes sheet cassettes 40, sheet feed rollers 41, sheet guide members 42, a pair of registration rollers 43, sheet discharge guide members 44, a pair of sheet discharge rollers 45, and so forth. According to the illustrative embodiment, two pairs of the sheet discharge rollers 45 are provided.

The sheet cassettes 40 consist of a top and a bottom cassettes, each of which stores a plurality of recording media sheets. Each of the sheet cassettes 40 is equipped with the sheet feed roller 41 that picks up and sends the recording medium P from the sheet cassette 40 one sheet at a time.

The sheet guide members 42 guide the recording medium P fed by the sheet feed roller 41 to the pair of registration rollers 43. Subsequently, the pair of registration rollers 43 directs the recording medium P guided from the sheet guide members 42 to the transfer nip such that the tip of the recording medium P contacts the transfer nip and stops. Then, the position of the recording medium is aligned.

Subsequently, the recording medium is sent in appropriate timing such that the recording medium P is aligned with the image formed on the secondary image bearing member 30.

The sheet discharge guide members 44 guide the recording medium P to the sheet discharge rollers 45 after the image on the recording medium P is fixed thereon. The sheet discharge rollers 45 serve as a sheet discharge device and discharge the recording medium P guided by the sheet discharge guide members 44 to the internal sheet discharge portion 112 in a direction indicated by arrow a.

It is to be noted that the direction indicated by arrow a is substantially the same as a first sheet discharge direction indicated by arrow 133 described later.

The fixing device H includes a pair of heating rollers 47 and fixes an image transferred onto the recording medium P from the primary transfer unit E and the secondary transfer unit F.

The toner feeding device J includes a toner storage unit 52 that is equipped with toner cartridges 53 of each color. The toner feeding device J supplies respective color of fresh toner to the image forming stations A, B, C, and D using pumps.

In the image forming apparatus 10, when forming a color image on both sides of the recording medium P, the original document is placed on the contact glass of the image reader 114 and a start button of the control panel 115 is pressed by the user.

Subsequently, the photoreceptor drums 12A, 12B, 12C, and 12D, one of the primary rollers 21, 22, and 23, one of the secondary rollers 32, 33, and 34, the sheet feed roller 41, and so forth start to rotate at proper timing.

In the image forming station A, as the photoreceptor drum 12A starts to rotate in a clockwise direction indicated by arrow, the charging device 13 evenly charges the surface of the photoreceptor drum 12A. The exposure unit 18 illuminates the photoreceptor drum 12A with a laser beam designated for the respective color of toner, in this case, yellow, thereby forming a latent image on the photoreceptor drum 12A.

Subsequently, the developing device 14A develops the latent image formed on the photoreceptor drums 12A by adhering yellow toner thereto, thereby forming a toner image of yellow. Similarly, toner images of different colors magenta, cyan, and black are formed on the photoreceptor drums 12B, 12C, and 12D.

In the primary transfer unit E, one of the primary rollers 21, 22, and 23 is driven to rotate and the other two rollers follow to rotate. The primary image bearing member 20 is rotated in a counterclockwise direction indicated by arrow in synchronization with rotation of the photoreceptor drums 12A through 12D.

While the primary image bearing member 20 rotates, bias voltage is applied thereto by the transfer members 15A through 15D so as to overlappingly transfer the toner image formed on each of the photoreceptor drums 12A, 12B, 12C, and 12D onto the primary image bearing member 20. Accordingly, a composite full-color primary image is formed.

After the image is transferred, toner remaining on the photoreceptor drum 12A of the image forming station A, hereinafter referred to as residual toner, is removed from the photoreceptor drum 12A by the cleaning device 16A. Subsequently, charge of the photoreceptor drum 12A is neutralized by the charge neutralizer 17A in preparation for the subsequent image forming cycle.

Subsequently, the photoreceptor drum 12A is charged by the charging device 13A, and exposed and optically written by the exposure unit 18, forming a latent image on the photoreceptor drum 12A again.

The latent image on the photoreceptor drum 12A is developed by the developing device 14A with toner, thereby forming a visible image (toner image) on the photoreceptor drum 12A.

It is to be noted that the same image forming cycle is performed in the image forming stations B, C, and D.

In the secondary transfer unit F, one of the secondary rollers 32, 33, and 34 is driven to rotate, and the other two rollers follow to rotate. The secondary image bearing member 30 is rotated in the clockwise direction in synchronization with rotation of the primary image bearing member 20.

The secondary image bearing member 30 is applied with bias voltage by the primary transfer member 25 so that the image on the primary image bearing member 20 is transferred onto the secondary image bearing member 30.

At this time, the secondary cleaning unit 35 turns about a shaft 56 to separate from the secondary image bearing member 30. This state is referred to as a non-cleaning state.

After the image is transferred from the primary image bearing member 20 of the primary transfer unit E to the secondary image bearing member 30, the residual toner is electrostatically removed from the primary image bearing member 20 by the primary cleaning unit 24.

Subsequently, the images on the photoreceptor drums 12A through 12D are sequentially transferred onto the primary image bearing member 20 by the transfer members 15A through 15D. Accordingly, a second four-color full image is formed.

After the image is transferred, the residual toner remaining on the photoreceptor drum 12A of the image forming station A is removed from the photoreceptor drum 12A by the cleaning device 16A. Subsequently, charge of the photoreceptor drum 12A is neutralized by the charge neutralizer 17A in preparation for the subsequent image forming cycle.

In the sheet transport device G, one of the sheet feed rollers 41 is selectively rotated so as to pick up and send the recording medium P stored in the sheet cassette 40 to the sheet guide members 42. The sheet guide members 42 guide the recording medium P such that the tip of the recording medium P arrives between the registration rollers 43 and stops.

Subsequently, the registration rollers 43 are rotated so as to send the recording medium P to the transfer nip between the primary image bearing member 20 and the secondary image bearing member 30 in appropriate timing such that the recording medium P is aligned with the first full-color image and the second full-color image described above.

Next, in the transfer nip, bias voltage is applied by the primary transfer member 25 from the rear surface of the recording medium P so as to transfer the second full-color image on the primary image bearing member 20 onto the front surface of the recording medium P. Then, the recording medium P is transported upward by a small amount.

Subsequently, bias voltage is applied from the front surface of the recording medium P by the secondary transfer device 36 so as to transfer the first full-color image on the secondary image bearing member 30 onto the rear surface of the recording medium P.

After the image is transferred on both sides of the recording medium P, the recording medium P is sent to the fixing device H. In the fixing device H, the recording medium P passes between the pair of the heating rollers 47 that applies heat and pressure to the image on the recording medium P, thereby fixing the image onto both sides of the recording medium P.

After fixing, the sheet discharge guide members 44 guide the recording medium P to switching claws, not illustrated, that direct the recording medium P to the appropriate pair of sheet discharge rollers 45.

The selected pair of the sheet discharge rollers 45 discharges the recording medium P face-down outside the housing of the image forming apparatus 10, onto a sheet receiver 50 of the internal sheet discharge portion 112.

After the image is transferred, the residual toner is removed from the primary image bearing member 20 of the primary transfer unit E by the primary cleaning unit 24.

The residual toner is removed from the secondary image bearing member 30 of the secondary transfer unit F such that the secondary cleaning unit 35 is turned about the shaft 56 so as to contact and clean the secondary image bearing member 30 in preparation for the subsequent image forming cycle.

When the toner in the developing devices 14A through 14D is consumed, the same color of toner is supplied from the toner cartridges 53 of the corresponding color in the toner storage unit 52 of the toner feeding device J using the pumps.

When paper jams occur, preventing transport of the recording medium P, the duplex unit 113 can be opened about a shaft 55 in a direction indicated by arrow d, thereby allowing the sheet transport path to become accessible for maintenance.

In a case in which a color image is formed only on one side of the recording medium P, images formed on the photoreceptor drums 12A through 12D in the image forming stations A through D are transferred onto the primary image bearing member 20 of the primary transfer unit E.

Subsequently, without transferring the image onto the secondary image bearing member 30 of the secondary transfer unit F, the image on the primary image bearing member 20 is directly transferred onto one side of the recording medium P being transported by the sheet transport device G.

Then, the image is fixed onto the recording medium P by the fixing device H. The recording medium P, onto which the image is fixed, is discharged face-down and sequentially collated onto the sheet receiver 50.

By contrast, when the image forming apparatus 10 forms a two-color image or a monochrome image on the recording medium P, the corresponding color of image forming station(s) among the image forming stations A through D is employed to form the image, and the image is transferred onto the recording medium P through the primary image bearing member 20 of the primary transfer unit E and the secondary image bearing member 30 of the secondary transfer unit F.

A description is now provided of the internal sheet discharge portion 112 according to the illustrative embodiment of the present invention with reference to accompanying drawings.

It is to be noted that the following description pertains to the pair of sheet discharge rollers 45. However, the number of the sheet discharge rollers 45 is not limited to a single pair. Alternatively, two pairs of the sheet discharge rollers 45 can be provided, and the same effect as that of the other embodiments can be achieved.

### Embodiment 1

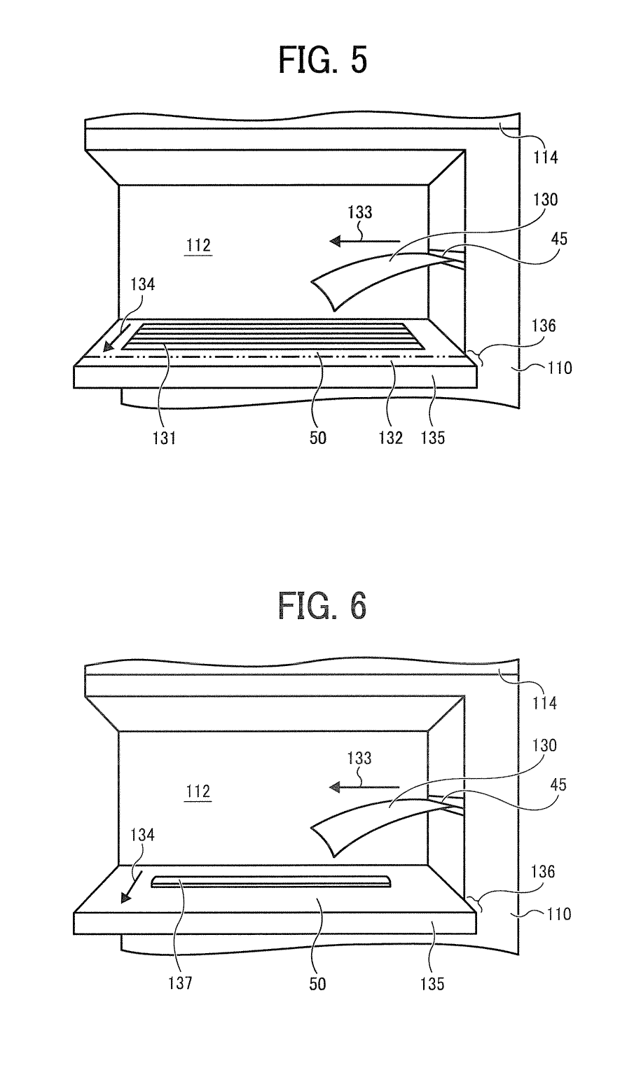

Referring now to FIG. 5, there is provided a schematic diagram illustrating the internal sheet discharge portion 112 of the image forming apparatus 10 according to one illustrative embodiment of the present invention.

As illustrated in FIG. 5, the image reader (scanner) 114 is provided substantially above the internal sheet discharge portion 112 in the image forming apparatus 10. Substantially below the internal sheet discharge portion 112, the image forming unit 110 (printing portion) is provided. In other words, the internal sheet discharge portion 112 is provided between the image reader 114 and the image forming unit 110.

After an image is formed on a recording medium 130 in the image forming unit 110, although not illustrated in FIG. 5, the recording medium 130 is transported along a lateral sheet transport path from the image forming unit 110 to the fixing device H.

After the image is fixed onto the recording medium 130, the recording medium 130 is discharged to the internal sheet discharge portion 112 through the pair of the sheet discharge rollers 45.

The recording medium 130 discharged to the internal sheet discharge portion 112 is stacked on the sheet receiver 50 of the internal sheet discharge portion 112 due to gravity.

On the upper surface of the sheet receiver 50, an endless sheet transport belt 131 serving as a sheet moving device is provided. The sheet transport belt 131 rotates in a direction indicated by arrow 134, that is, a direction toward a front or proximal side 135 closest to the user.

The sheet transport belt 131 is stretched between two pulleys, not illustrated. The pulleys are disposed parallel to one another in the direction of sheet discharge.

As the sheet transport belt 131 rotates in the direction of arrow 134, the recording medium 130 is transported in the direction of arrow 134, that is, a second sheet discharge direction. The sheet transport belt 131 is driven by a motor, not illustrated. The motor is driven in accordance with an instruction from a control circuit, not illustrated.

The direction indicated by arrow 134 is substantially perpendicular to the direction indicated by arrow 133, that is, a first sheet discharge direction. Accordingly, the recording medium 130 discharged in the direction indicated by arrow 133, the first sheet discharge direction, is then directed in the direction of arrow 134, that is, the second sheet discharge direction, thereby enabling the recording medium 130 to move forward and project from the front side 135.

An amount of the projection of the recording medium 130 is preferably, for example, an amount that allows a user to pick up the recording medium 130 by his or her fingers from the front side of the image forming apparatus 10.

Alternatively, in order to accommodate traveling of the recording medium 130, the sheet receiver 50 can be extended in a projecting manner from the front portion or the proximal end of the image forming apparatus 10 by a predetermined amount. The projecting portion of the sheet receiver 50 is indicated by a reference number 136.

When the projection 136 is provided, a ground-projected area increases by an amount of the projection 136. However, the projection 136 is at the front side or the proximal end of the image forming apparatus 10. Therefore, the image forming apparatus 10 can still be installed next to or in the vicinity of a wall or other equipment, and operability by the user can also be assured.

The recording medium 130 is moved to the front side of the image forming apparatus 10 when a job requested by the user is completed. In a case in which image forming operation is performed on a plurality of the recording media in a single job, the plurality of recording media is not moved to the front side until the image forming operation on all the plurality of recording media in the job is completed.

When the recording medium 130 discharged to the internal sheet discharge portion 112 is then transported substantially to the front side or the proximal end closest to the user, the recording medium 130 can be easily seen by the user, thereby facilitating the user taking out the recording medium 130 from the internal sheet discharge portion 112.

According to the illustrative embodiment, the description is provided of a copier as one example of an image forming apparatus. However, the image forming apparatus is not limited to the copier. The same effect as that of the foregoing description can be achieved when the present invention is applied to a printer and a facsimile machine.

### Embodiment 2

Referring now to FIG. 6, there is provided a schematic diagram illustrating the internal sheet discharge portion 112 of the image forming apparatus 10 according to a variation of the foregoing embodiment.

According to the present embodiment, a sheet discharge roller 137 is provided in place of the sheet transport belt 131. The sheet discharge roller 137 is driven by a motor, not illustrated, and enabled to move the recording medium 130 substantially to the front side or the proximal end closest to the user. With this configuration, the same effect as that of the foregoing embodiment can be achieved.

It is to be noted that, except for the sheet discharge roller 137, each component according to the present embodiment is the same and has the same function as that of the foregoing embodiment, unless otherwise specified.

### Embodiment 3

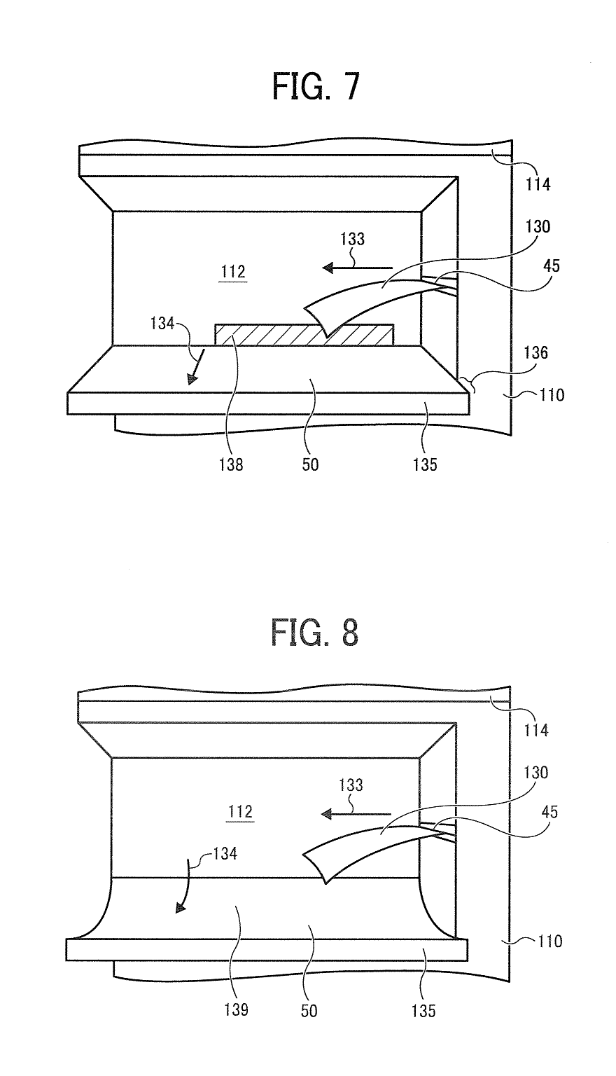

Referring now to FIG. 7, there is provided a schematic diagram illustrating the internal sheet discharge portion 112 of the image forming apparatus 10 according to a variation of the foregoing embodiments.

According to the present embodiment, a push member 138 is provided in place of the sheet transport belt 131 of Embodiment 1.

The push member 138 is configured to move the recording medium 130 from substantially the back of the internal sheet discharge portion 112 to the front side or the proximal end closest to the user.

Configuration for moving the push member 138 to the front side includes, but is not limited to, a screw driven by a motor, using a linear motor, using magnetic force, and so forth. Any other suitable driving devices can be employed.

It is to be noted that, except for the push member 138, each component according to the present embodiment is the same and has the same function as that of the foregoing embodiment, unless otherwise specified.

### Embodiment 4

Referring now to FIG. 8, there is provided a schematic diagram illustrating the internal sheet discharge portion 112 of the image forming apparatus 10 according to a variation of the foregoing embodiments.

According to the present embodiment, the sheet receiver 50 includes a sloped surface 139.

The sloped surface 139 is provided such that a substantially front side of the sheet receiver 50 is tilted downward. With this configuration, when the recording medium 130 is discharged onto the sloped surface 139 of the sheet receiver 50 in the first sheet discharge direction 133, the recording medium 130, then, naturally travels in the second sheet discharge direction 134 due to gravity. Accordingly, the recording sheet 130 approaches the front side of the sheet receiver 50 of the image forming apparatus 10, that is, toward the user.

According to the present embodiment, as illustrated in FIG. 8, the sloped surface 139 of the sheet receiver 50 has a substantially curved surface instead of a flat surface. By contrast, the front side 135 has a substantially horizontal surface.

When the sloped surface 139 is curved and the front side 135 has a horizontal surface, the front end of the recording medium 130, that is, the leading end of the recording medium 130 in the direction of travel, is prevented from traveling further due to frictional force, thereby preventing the recording medium 130 from falling off from the sheet receiver 50.

Accordingly, the recording medium 130 is moved to, but stopped at a position where the user can easily grasp the recording medium 130.

With this configuration, the devices such as the motor, the sheet transport belt 131, the sheet discharge roller 137, the push member 138, dedicated for moving the recording medium 130, are not necessitated, thereby reducing initial and running cost and thus achieving the most economical device.

It is to be noted that, except for the sloped surface 139, each component according to the present embodiment is the same and has the same function as that of the foregoing embodiment, unless otherwise specified.

### Embodiment 5

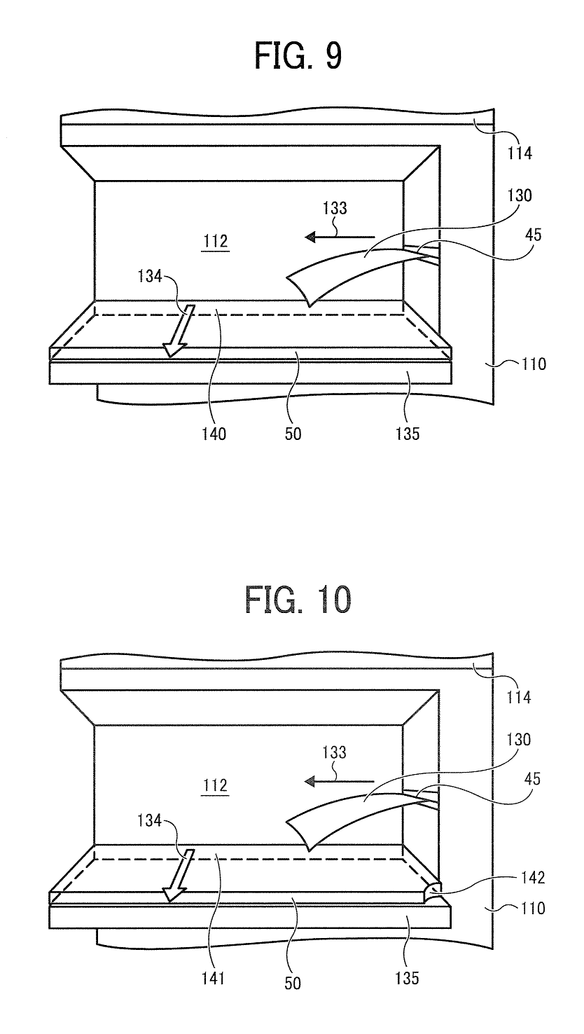

Referring now to FIG. 9, there is provided a schematic diagram illustrating the internal sheet discharge portion 112 of the image forming apparatus 10 according to a variation of the foregoing embodiments.

According to the present embodiment, a movable sheet discharge tray 140 is provided in place of the sheet transport belt 131 of Embodiment 1. The discharge tray 140 is movable and the size thereof is small enough to fit in the sheet discharge portion 112 when the discharge tray 140 is in a retracted position in the sheet discharge portion 112.

When the sheet discharge tray 140 is in the retracted position in the sheet discharge portion 112, the sheet discharge tray 140 is within the projected area as viewed from substantially the top of the image forming apparatus 10.

Since the discharge tray 140 is movable, there is no need to provide a projecting portion such as the projection 136 that facilitates the user to grasp the recording medium 130.

According to the present embodiment, the sheet discharge tray 140 is mounted on two rollers such as the sheet discharge roller 137 of Embodiment 2. Such rollers are provided parallel to one another, one substantially at the front side of the sheet receiver 50 of the internal sheet discharge portion 112 and the other substantially at the back thereof.

When mounted on the rollers, the sheet discharge tray 140 is able to reciprocally move in the direction of sheet discharge that is perpendicular to the first sheet discharge direction 133.

Furthermore, similar to the push member 138, configuration for driving the sheet discharge tray 140 includes, but is not limited to, a screw driven by a motor, using a linear motor, using magnetic force, and so forth. Any other suitable driving mechanism can be employed.

The sheet discharge tray 140 is moved to the front for each job (each operation) instructed by the user. Before the subsequent job is initiated, that is, before the same user starts printing operation of another document, or before a different user starts printing operation, the sheet discharge tray 140 moves to the front so as to transport the recording medium 130 to the front and the subsequent printing operation is initiated.

The sheet discharge tray 140 is retracted back to the internal sheet discharge portion 112 before the next first sheet is discharged.

Alternatively, the sheet discharge tray 140 is moved to the front when one user completes his or her printing operation, and the sheet discharge tray 140 is retracted back after the user picks up the recording medium 130 from the sheet discharge tray 140.

The timing of the reciprocal movement of the sheet discharge tray 140 can be determined by the user through the control panel. In other words, the timing with which the sheet discharge tray 140 moves to the front in the second sheet discharge direction and retracts back can be set from the control panel of the image forming apparatus 10 by the user.

It is to be noted that, without limitation to the present embodiment; the timing with which the recording medium 130 discharged onto the sheet receiver 50 is moved in the second sheet discharge direction 134 can be set from the control panel by the user.

It is to be noted that, except for the sheet discharge tray 140, each component according to the present embodiment is the same and has the same function as that of the foregoing embodiment, unless otherwise specified.

### Embodiment 6

Referring now to FIG. 10, there is provided a schematic diagram illustrating the internal sheet discharge portion 112 of the image forming apparatus 10 according to a variation of the foregoing embodiments.

According to the present embodiment, a sheet discharge tray 141 includes a notch 142 at a front corner of the sheet discharge tray 141. The size of the notch 142 is large enough for a finger or a hand of the user to fit, while being small enough to prevent the recording sheet 130 from falling off from the sheet discharge tray 141 or from being deformed.

It is to be noted that the except for the sheet discharge tray 140, each component according to the present embodiment is the same and has the same function as that of the foregoing embodiments 1 and 5, unless otherwise specified.

### Embodiment 7

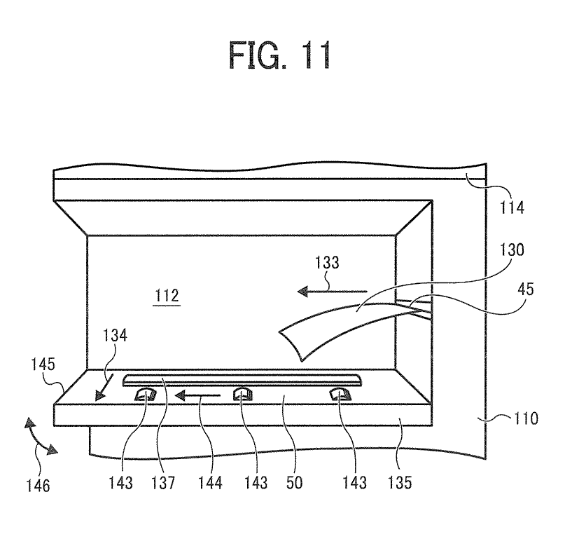

Referring now to FIG. 11, there is provided a schematic diagram illustrating the internal sheet discharge portion 112 of the image forming apparatus 10 according to a variation of the foregoing embodiments.

According to the present embodiment, the recording medium 130 is discharged in a third sheet discharge direction indicated by arrow 144 in addition to the first sheet discharge direction 133 and the second sheet discharge direction 134.

In order to satisfy the purpose of reducing the footprint of the image forming apparatus 10 in which the recording medium is discharged internally, the foregoing embodiments assume that the recording medium 130 is taken out by the user only from the front side of the image forming apparatus 10, that is, the side from which the user operates.

In general, in this type of the image forming apparatus in which the recording medium is discharged internally as illustrated in FIGS. 2 and 3, the front and the left sides of the internal sheet discharge portion 112 as viewed from the front are open so that the recording medium 130 can be retrieved therefrom. The front side 135 in FIG. 11 is the equivalent of the front side at which the user operates in FIGS. 2 and 3. A left side 145 in FIG. 11 is the equivalent of the left side as viewed from the front side in FIGS. 2 and 3.

In other words, when the left side 145 of the image forming apparatus 10 is not next to or in the vicinity of an object such as a wall, other devices, and so forth, the recording medium 130 can be retrieved from the left side 145.

In such a case also, the recording medium 130 is discharged onto the sheet receiver 50 in the internal sheet discharge portion 112. In particular, when the size of the recording medium 130 is relatively small, the leading end of the recording medium 130 is discharged to a place away from the opening at the left side 145, thereby making it difficult for the user to reach the recording medium 130.

In view of the above, according to the present embodiment, a plurality of sheet discharge rollers 143 is provided to the sheet receiver 50 in addition to the sheet discharge roller 137 so as to move the recording medium 130 once discharged onto the sheet receiver 50 further in the third sheet discharge direction 144.

The sheet discharge roller 137 is hereinafter referred to as a first sheet discharge roller 137. The plurality of the sheet discharge rollers 143 is hereinafter referred to as second sheet discharge rollers 143.

It is to be noted that the third sheet discharge direction 144 is substantially the same direction as the first sheet discharge direction 133. However, the third sheet discharge direction 144 refers to the discharge direction of the recording medium 130 after the recording medium 130 is discharged onto the sheet receiver 50.

The plurality of the second sheet discharge rollers 143 rotate parallel to the first sheet discharge direction 133.

The first sheet discharge roller 137 and the plurality of the second sheet discharge rollers 143 are disposed such that the first sheet discharge roller 137 and the plurality of the second sheet discharge rollers 143 project by substantially the same amount from the upper surface of the sheet receiver 50 so as to contact the bottom surface of the recording medium 130.

Rotation axes of the plurality of the second sheet discharge rollers 143 are disposed in a direction perpendicular to the first sheet discharge direction 133. In other words, the rotation axes of the plurality of the second sheet discharge rollers 143 are perpendicular to a rotation axis of the first sheet discharge roller 137.

When the plurality of the second sheet discharge rollers 143 is rotated by a predetermined amount, the recording medium 130 can be transported in the third sheet direction 144 by the predetermined or a desired amount so that the recording medium 130 can be taken out from the left side 145.

The amount by which the recording medium 130 is moved in the third sheet discharge direction 144 varies depending on the size of the recording medium 130. In other words, the amount by which the recording medium 130 is moved varies depending on the distance between the leading end of the recording medium 130 and the opening at the left side 145.

Therefore, depending on the distance, the amount by which the leading end of the recording medium 130 projects from the opening at the left side 145 is automatically set by a control circuit, not illustrated, and the recording medium 130 is moved accordingly.

With this configuration, the recording medium 130 can be taken out from the left side 145 of the image forming apparatus 10 with ease.

According to the present embodiment, the recording medium 130 is moved in the second sheet discharge direction 134 by the first sheet discharge roller 137. Furthermore, the recording medium 130 is moved in the third-sheet discharge direction 144 by the plurality of the second sheet discharge rollers 143. Therefore, with the combination of the first sheet discharge roller 137 and the second sheet discharge rollers 144, the recording medium 130 or a stack of recording media sheets can be rotated on the sheet receiver 50.

In other words, when the first sheet discharge roller 137 is rotated in the frontal direction and the second sheet discharge rollers 143 are turned to the left, the recording medium 130 turns in a clockwise direction, thereby causing the right front corner portion of the recording medium 130 to project farthest from the sheet discharge portion 112.

The rotation of the first sheet discharge roller 137 and the second sheet discharge rollers 143 are set to stop when the recording medium 130 projects from the sheet discharge portion 112 so that the user can easily pick up the right front corner portion of the recording medium 130 from the sheet discharge portion 112.

By contrast, when the first sheet discharge roller 137 is rotated in the frontal direction and the second sheet discharge rollers 143 are rotated to the right, the recording medium 130 rotates in a counterclockwise direction, thereby causing the left front corner portion of the recording medium 130 to project farthest from the sheet discharge portion 112.

The rotation of the first sheet discharge roller 137 and the second sheet discharge rollers 143 are set to stop when the recording medium 130 projects from the sheet discharge portion 112, so that the user can easily pick up the left front corner portion of the recording medium 130 from the sheet discharge portion 112.

There may be a case in which, upon rotation of the recording medium 130, the corner portion of the recording medium 130 may interfere with a wall of the sheet discharge portion 112. In such a case, the recording medium 130 can be moved in the second sheet discharge direction 134 as well as the third sheet discharge direction 144 in advance so as not to interfere with the wall of the sheet discharge portion 112, and then the recording medium 130 can be rotated from that position.

Furthermore, alternatively, when the sheet discharge tray 140 is mounted on the first sheet discharge roller 137 and the second sheet discharge rollers 143, the recording medium 130 is placed on a planar surface. Accordingly, the recording medium 130 can be smoothly transported in the second sheet discharge direction 134, the third sheet discharge direction 144, or a rotation direction 146 that is a composite of the second and the third discharge directions.

Alternatively, the notch 142 illustrated in FIG. 9 can be provided to the sheet discharge tray 141 at a position allowing the user to easily pick up the recording medium 130 when the recording medium 130 is turned in the rotation direction 146.

According to the present embodiment, the first sheet discharge roller 137 and the plurality of the second sheet discharge rollers 143 move directly the recording medium 130 or the sheet discharge tray 141. Alternatively, however, a belt member can be employed instead of the roller, or a combination of both can be employed.

It is to be noted that, unless otherwise stated, each component according to the present embodiment is the same and has the same function as that of the foregoing embodiments 1, 5, and 6.

A detailed description of a driving mechanism for moving the recording medium is omitted herein. However, known mechanical devices can be employed for the driving mechanism moving in a single direction or different directions achieved by combining the directions. Therefore, those skilled in the art will readily recognize the driving mechanism for moving the recording medium.

According to the illustrative embodiments, the present invention is applied to the copier as an example of an image forming apparatus in which the recording medium is internally discharged. However, as long as an image forming apparatus is equipped with a sheet discharge portion in which the recording medium is moved, the present invention is also applicable.

The recording medium 130 can be transported substantially to the front side of the image forming apparatus 10 so that the user is able to see and easily pick up the recording medium 130.

The endless sheet transport belt 131, the sheet discharge roller 137 (the first sheet discharge roller), and the push member 138 are employed as the devices for moving the recording medium 130. With this configuration, the recording medium 130 can be moved with a relatively simple configuration

The sloped surface 139 allows the recording medium 130 to move to the front side due to gravity, thereby not necessitating any power, thus achieving cost reduction.

The sheet discharge tray 140 is movably mounted on the sheet receiver 50 and moves itself to the front side so that a plurality of the recording media sheets stacked thereon are not disorganized as the recording media sheets are discharged.

The sheet discharge tray 141 includes the notch 142, thereby facilitating the user to pick up the recording medium 130 from the internal sheet discharge portion 112.

With the combination of the sheet discharge devices that move in different moving directions, the recording medium 130 can be moved in a direction most desirable for the user.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Still further, any one of the above-described and other exemplary features of the present invention may be embodied in the form of an apparatus, method, or system.

For example, any of the aforementioned methods may be embodied in the form of a system or device, including, but not limited to, any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. An image forming apparatus for forming an image, comprising:
an image reader to read an image of a document, provided substantially at an upper portion of the image forming apparatus;
an image forming unit to form an image based on image information read by the image reader and transfer the image onto a recording medium, disposed substantially below the image reader so as to define a space between an upper portion of the image forming unit and a bottom portion of the image reader;
a sheet discharge device to discharge the recording medium on which an image is formed;
a sheet receiver to receive the recording medium discharged by the sheet discharge device, provided in the space between the upper portion of the image forming unit and the bottom portion of the image reader; and
a sheet moving mechanism to move the recording medium that is discharged onto the sheet receiver by the sheet discharge device in a desired direction.

2. The image forming apparatus according to claim 1, wherein the sheet discharge device discharges the recording medium onto the sheet receiver in a first direction,
the sheet moving mechanism including a first sheet moving device that moves the discharged recording medium on the sheet receiver in a second sheet discharge direction that is a frontal direction toward a user and substantially perpendicular to the first sheet discharge direction.

3. The image forming apparatus according to claim 2, wherein the sheet moving mechanism further includes a second sheet moving device that moves the discharged recording medium on the sheet receiver in a third sheet discharge direction parallel to the first sheet discharge direction.

4. The image forming apparatus according to claim 3, wherein the recording medium is rotated to a desired position by combining driving of the first and the second sheet moving devices of the sheet moving mechanism.

5. The image forming apparatus according to claim 2, wherein the first sheet moving device is one of a belt member and a roller member that contacts and transports the recording medium.

6. The image forming apparatus according to claim 3, wherein the second sheet moving device is one of a belt member and a roller member that contacts and transports the recording medium.

7. The image forming apparatus according to claim 2, wherein the first sheet moving device moves the recording medium by pushing.

8. The image forming apparatus according to claim 2, wherein the sheet receiver includes the first sheet moving device including a sloped surface that allows the recording medium to glide thereon.

9. The image forming apparatus according to claim 2, wherein the first sheet moving device includes a sheet discharge tray, movably mountable on the upper surface of the sheet receiver, which transports the recording medium.

10. The image forming apparatus according to claim 9, wherein the sheet discharge tray is disposed on one of the belt member and the roller member that moves in the second sheet discharge direction so as to move the sheet discharge tray in the second sheet discharge direction.

11. The image forming apparatus according to claim 9, wherein the sheet discharge tray is disposed on one of the belt member and the roller member that moves in the second sheet discharge direction and on one of the belt member and the roller member that moves in the third sheet discharge direction, and the sheet discharge tray rotatably moves in a direction that is a composite of the second and third sheet discharge directions.

12. The image forming apparatus according to claim 9, wherein a front side of the sheet discharge tray includes a notch.

13. The image forming apparatus according to claim 9, wherein at least one corner of the front side of the sheet discharge tray includes a notch.
